(19) United States
(12) Patent Application Publication
(10) Pub. No.: US 2007/0220147 A1
(43) Pub. Date: Sep. 20, 2007

(54) Method for Provisioning a Server in a Computer Arrangement

(75) Inventors: Joseph W. Armstrong, Santa Cruz, CA (US); Shu-Ching Hsu, Fremont, CA (US); Mark Johnston, Campbell, CA (US); Rahul Kelkar, Fremont, CA (US); Judy King, San Luis Obispo, CA (US); Brian Kress, Brockport, NY (US); Radhika Pennepalli, Fremont, CA (US); Kesava Pulijala, Santa Clara, CA (US); Guangji Shen, San Jose, CA (US); Pushkar Singh, Fremont, CA (US); Keven Stoner, San Jose, CA (US); Rajendran Vishwanathan, San Jose, CA (US)

Correspondence Address: EDELL, SHAPIRO & FINNAN, LLC, 1901 RESEARCH BOULEVARD, SUITE 400, ROCKVILLE, MD, 20850, US

(73) Assignee: FUJITSU SIEMENS COMPUTERS, INC., Sunnyvale, CA (US)

(21) Appl. No.: 11/674,196

(22) Filed: Feb. 13, 2007

Related U.S. Application Data
(63) Continuation of application No. PCT/EP05/09399, filed on Aug. 31, 2005.
(60) Provisional application No. 60/608,525, filed on Sep. 9, 2004.

(51) Int. Cl. G06F 15/173

(52) U.S. Cl. 709/225

(57) ABSTRACT

A method for provisioning servers in a computer arrangement allows more than one administrator to utilize the servers and prevents the servers from being influenced by more than one administrator at the same time. The computer arrangement includes at least one server, at least one administrator operable to control the usage of the servers by making provisioning decisions, and a deployment server operable to provision the servers according to the provisioning decisions of the administrators. An administrator is required to exclusively reserve the server before the administration unit can use the server. This prevents the server from being used by two or more interfering administrators, meanwhile allowing a flexible assignment between servers and administrators.

### CROSS REFERENCE TO RELATED APPLICATIONS

This application is a continuation of International Application No. PCT/EP2005/009399, filed on Aug. 31, 2005, entitled “Method for Provisioning a Server in a Computer Arrangement,” which claims the benefit of U.S. Provisional Application No. 60/608,525, filed on Sep. 9, 2004, the entire contents of which are hereby incorporated by reference.

### BACKGROUND

Computer networks typically include at least one computer called a server and one or more computers called clients. Clients can request certain services provided over the network which are provided by the servers.

Often a network service provider runs a plurality of servers (called a server farm) in order to be able to handle all incoming requests. Considering the growing size of modern server farms, which can consist of hundreds of servers, there is an increasing demand to automate administrative tasks like allocating and configuring available resources, i.e., servers. The approach to automate administrative tasks is known as autonomous computing (AC). A central element in an AC-environment is an administration capability, referred to herein as an “administrator,” to perform administrative tasks. Sometimes, the administrator in AC is referred to as a decision engine (DE) or a controller, for example. Usually the administrator is hosted on a computer within the network that is neither a server nor a client, but specifically designated for administrative tasks. The administrator is capable of dynamically allocating or freeing servers and setting them up to provide services for which an actual demand exists. This process of allocating and setting up (i.e., configuring) servers is also called “provisioning of servers.”

Different methods to provision servers by an administrator are known. One known way is to remotely start or stop instances of an application depending on requirements. This bears the danger of collecting remains of all applications that were once started and stopped again (e.g., temporary files) which might lead to an unstable and slow system. Therefore, often another approach, sometimes called “bare-metal provisioning” is chosen, where for each new task (e.g., different customer, different applications) a whole boot image is transferred to a server and the server is re-booted with the new boot image.

Sometimes the decision making process is separated from the actual process of provisioning. In such a case, the decision making component is still referred to as the administrator (or decision engine) and the unit that carries out the actual provisioning is called a deployment server.

Decisions of the administrator are based on a number of criteria and basic conditions (e.g., actual demands, the capacity that is theoretically available, and the actual capacity which might be decreased due to failures). Also, non-technical but economical considerations, for example, different priorities of certain services, might be taken into account. Therefore, customers of server farms often prefer to use an administrator which is optimized to meet their requirements. This results in a situation in which several administrators are used in a computing arrangement in parallel, usually in combination with a common deployment server. Problems then arise if two or more administrators try to provision the same server. To date, this could be prevented only by the intervention of a human administrator, e.g., by manually dividing the available servers into subsets and assigning different subsets to different administrators. This solution has the disadvantage of being very inflexible. Since it is difficult to manually check and re-adjust the size of subsets continuously, this solution is likely to lead to a situation in which unused servers are present in one subset and overloaded servers in another. It is also an expensive and error-prone solution.

### SUMMARY

The invention generally relates to a method and computer arrangement for provisioning a server in a computer arrangement, in particular a computer arrangement which comprises a plurality of servers, designated to provide service to clients over a network, at least one administrator, set up to control the usage of the servers by making provisioning decisions (based on input parameters and predetermined rules), and a deployment server connected to the administrators and to the servers according to the provisioning decisions of the administrators.

According to an exemplary embodiment of the invention, a method for provisioning servers in a computer arrangement allows more than one administrator to utilize the servers while nevertheless preventing the servers from being influenced by more than one administrator at the same time. An exemplary method for provisioning a server in a computer arrangement includes the following operations. Prior to a provisioning request, a reservation request concerning one of the servers is transmitted from the administrator to the deployment server. Upon reception of a reservation request, the reservation is granted and the reservation information is updated if the concerned server it is not already reserved, or otherwise, the reservation is denied if the concerned server it is already reserved. Upon reception of a provisioning request by one of the administrators concerning one of the servers, the provisioning is performed if the concerned server is reserved by the server and denied otherwise.

According to another aspect of the invention, a reservation system for servers is created within the deployment server. Before any user of the deployment server (i.e., any automated administrator or human administrator) can use a server, it has to exclusively reserve the server. Once a server is reserved for a given administrator, no other administrator can use it. This reservation system prevents the server from being used by two or more interfering administrators without having a rigid and inflexible assignment between servers and administrations.

The above and still further features and advantages of the method and computer arrangement will become apparent upon consideration of the following definitions, descriptions and descriptive figures of specific embodiments thereof, wherein like reference numerals in the various figures are utilized to designate like components. While these descriptions go into specific details of the method and computer arrangement, it should be understood that variations may and do exist and would be apparent to those skilled in the art based on the descriptions herein.

### BRIEF DESCRIPTION OF THE DRAWINGS

The method for provisioning a server and the computer arrangement is explained in more detail below with reference to exemplary embodiments, where:

FIG. 1 is a conceptual diagram of one embodiment of the described computer arrangement according to an exemplary embodiment of the invention; and

FIG. 2 is a flow-chart of one embodiment of the described method for provisioning a server in a computer arrangement according to an exemplary embodiment of the invention.

### DETAILED DESCRIPTION

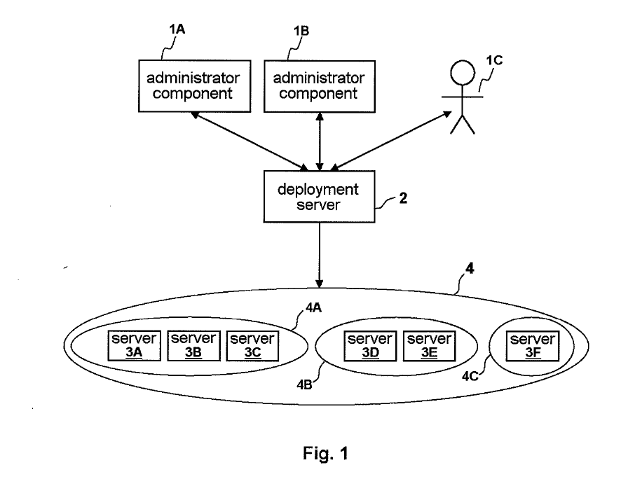

FIG. 1 shows two automated administrators (or simply “administrators”) 1A, 1B, which are connected to a deployment server 2 and a human administrator 1C capable of accessing the deployment server 2. The deployment server 2 is in charge of a group 4 of several servers 3 (3A to 3F). The group 4 of servers 3 is divided into several subsets 4A to 4C, of which subset 4A comprises the servers 3A to 3C, subset 4B comprises the servers 3D and 3E and subset 4C comprises server 3F.

For reasons of simplicity, the computer arrangement shown in FIG. 1 is limited to those parts which are characteristic for the described computer arrangement. For example, although no network connection, over which the servers 3 provide their services to clients is shown, it is to be understood that such a component is present in an implementation of the computer arrangement.

Also, the number of administrators and servers shown in the diagram are just exemplary. Computer arrangements for providing services to clients over a network often comprise several tens or even hundreds of servers. The described method can be easily applied to computer arrangements (server farms) of any size. The servers 3 can either be independent physical units (e.g., blade servers), or can be virtual servers. Virtual servers share a common hardware which runs software that emulates several hardware units.

In the example shown, three administration means are present, two of which (1A and 1B) are autonomous computing solutions, (e.g., working for different customers using the computer arrangement). The third administration means is a human user, for example a human system administrator, using a terminal or any other input/output mechanism. Although a purpose of the invention is to control the provisioning of servers 3 via automated administrators 1A and 1B, human system administrators (i.e., users) can take advantage of the reservation system provided, e.g., to get undisturbed access to servers 3 for maintenance purposes.

The administrators 1A and 1B are connected to the deployment server 2 which is configured to receive messages from and send messages to the administrators. The deployment server 2 is in authority over all servers 3 belonging to the group 4. The deployment server 2 is connected to all of the servers 3, as shown in FIG. 1 (e.g., servers 3A to 3F), and configured to provision the servers 3. As mentioned above, different methods to provision servers are known (e.g., bare metal provisioning or starting and stopping of servers and applications hosted on the servers). All techniques to provision and control servers could be used by the deployment server 2. The connections between deployment server 2 and administrators 1 or servers 3, respectively, could be realized as an independent network for security and/or performance reasons. In another embodiment, the same network that connects the servers 3 to clients (not shown in FIG. 1 for simplification), could also be used to exchange the messages between the administrators 1 and the deployment server 2 and to transmit the provisioning and control information between the deployment server 2 and the servers 3.

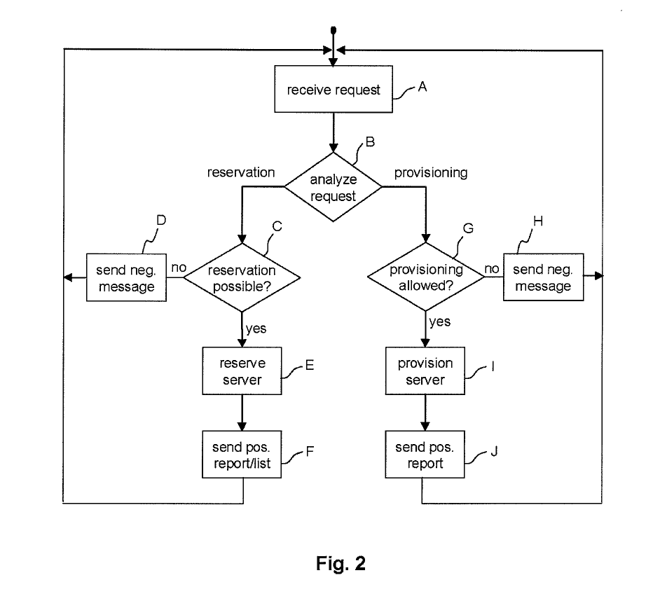

In FIG. 1, the servers 3 in subsets 4A, 4B, and 4C are reserved to be used by the administrators 1A, 1B, 1C, respectively. The reservation procedure according to the described method, which led to the formation of the logical subgroups 4A, 4B and 4C is described in the following in connection with FIG. 2.

FIG. 2 shows a flow-chart of an embodiment of the described method. In step A, a request is sent from one of the administrators 1 to the deployment server 2. The request can either concern the reservation of a certain server 3 or a number of servers 3 for future provisioning, or it can concern the provisioning of a particular server 3 that has already been previously reserved.

After reception of the request, the deployment server 2 analyzes the request in step B and branches to step C if the request is a reservation request, or it branches to step G if the request is a provisioning request. Requests can be of any format agreed on, but preferably a well-structured description language, for example XML (eXtensible Mark-up Language) is used.

Assuming now that the request received by the deployment server 2 is a reservation request, the method continues with step C. The reservation request can either be directed towards a particular server 3 or towards a number of servers 3 for subsequent provisioning. In the first case, a unique identifier of the particular server 3 to be reserved is transmitted. This unique identifier could, for example, be a network name or a network address of the particular server 3 within the computer arrangement. This first case of reservation request could for example be used if an administrator 1A or 1B prefers to make use of a particular server 3 due to the server's performance. It would also be selected if a human system administrator 1C would like to perform maintenance or debugging tasks on a particular server 3. The second case will be used if it is irrelevant which server 3 or servers 3 will be reserved, as long as the requested number of servers 3 is available. In another embodiment, a third type of reservation request can be implemented, which is not directed to particular servers 3 but on certain types of servers 3. Administrator 1 can then, for example, request a certain number of a first type of servers 3 and another number of a second type of servers 3, where the types of servers 3 differ in their performance or the operating system or the architecture of the servers 3.

The deployment server 2 subsequently checks whether it is possible to make the reservation or not. If the request concerns a particular server 3, the deployment server 2 will check whether this particular server 3 is still available or whether it is already reserved for another administrator 1. If the request concerns a number of servers 3, the deployment server 2 will look for available, i.e., not yet reserved servers 3 and will generate a list of identifiers of the available servers 3. The identifiers can again be, for example, the network names or network addresses of the servers 3. All reservation information is kept by the deployment server in a list or a table or any other appropriate data structure.

If it is not possible to make the requested reservation, a message to report the negative result is generated and transmitted to the requesting administrator 1 in step D.

If a successful or partly successful reservation was made, the reservation information is updated accordingly in step E. In step F, a message is subsequently generated to report the positive result of the reservation process. If a number of servers was requested, the message also contains the list comprising the identifiers of the reserved servers 3. The message is transmitted back to the administrator 1 that sent the request. The method then restarts with step A, ready to receive further requests.

After the reception of a positive report on a reservation request, the administrator 1 is now informed that a particular server 3 is available or, if a number of servers was requested, the administrator 1 now possess the identifiers of the reserved servers 3.

The administrator 1 then sends the actual provisioning request to the deployment server 2 (again step A). This request is analyzed in step B to be a provisioning request and accordingly the method continues with step G.

A provisioning request contains at least the identifier of the server 3 to be provisioned and optional provisioning parameters. In step G, the deployment server 2 ensures that the server 3 to be provisioned is reserved for the administrator 1 that sent the provisioning request. If it is not, the provision is rejected and a negative message is generated in step H and sent back to the requesting administrator 1. If the server 3 is reserved for the requesting administrator 1, the server 3 is provisioned in step I of the described method and a positive feedback message is sent back to the requesting administrator in step J. The method starts again with step A, being ready for further requests.

Not shown in FIG. 2 are further possible requests, e.g., to cancel a reservation. If the administrator 1 no longer desires a reserved server 3 that it reserved, the administrator 1 sends a cancellation request concerning this particular reserved server 3 to the deployment server 2. The deployment server 2 subsequently checks that this particular reserved server 3 is indeed reserved for the requesting administrator 1. If it is, the reservation is cancelled and the reservation information is updated accordingly.

While the method and computer arrangement have been described in detail with reference to specific embodiments thereof, it will be apparent to one of ordinary skill in the art that various changes and modifications can be made therein without departing from the spirit and scope thereof. Accordingly, it is intended that the described method and computer arrangement cover the modifications and variations provided they come within the scope of the appended claims and their equivalents.

What is claimed is:

1. A method for provisioning a server in a computer arrangement including: a plurality of servers designated to provide services to clients over a network; a plurality of automated administrators configured to control usage of the servers by making provisioning decisions based on input parameters and predetermined rules; and a deployment server coupled to the administrators and to the servers and configured to provision the servers according to the provisioning decisions of the administrators, the method comprising:
transmitting a reservation request from one of the administrators to the deployment server requesting reservation of at least one of the servers;
reserving the at least one server in the event the at least one server is not already reserved and denying the reservation request in the event the at least one server is already reserved;
transmitting a provisioning request from one of the administrators to the deployment server requesting provisioning of at least one of the servers; and
provisioning the at least one of the servers to the one of the administrators in the event the at least one of the servers has been reserved by the one of the administrators, and denying the provisioning request from the one of the administrators in the event the at least one server has not been reserved by the one of the administrators.

2. The method according to claim 1, further comprising:
transmitting a response message from the deployment server to the one of the administrators requesting the reservation, the response message indicating whether the reservation is granted or denied.

3. The method according to claim 2, wherein the reservation request relates to reservation of a plurality of the servers, and the response message identifies which of the servers are reserved.

4. The method according to claim 2, wherein requests to and messages from the deployment server are in the form of mark-up language based transactions.

5. The method according to claim 4, wherein the requests to and the messages from the deployment server are in the form of XML-based (eXtensible Markup Language) transactions.

6. The method according to claim 1, further comprising:
receiving at the deployment server a reservation request from a user.

7. A computer arrangement, comprising:
a plurality of servers designated to provide services to clients over a network;
a plurality of automated administrators configured to control usage of the servers by making provisioning decisions based on input parameters and predetermined rules; and
a deployment server coupled to the administrators and to the servers and configured to provision the servers according to provisioning decisions of the administrators, wherein:
the administrators transmit reservation requests to the deployment server requesting reservation of at least one of the servers, and the deployment server reserves the at least one server in the event the at least one server is not already reserved and denies a reservation request in the event the at least one server is already reserved; and
the administrators transmit provisioning requests to the deployment server requesting provisioning of at least one of the servers, the deployment server provisioning the at least one of the servers to one of the administrators in the event the at least one of the servers has been reserved by the one of the administrators, and denying a provisioning request from the one of the administrators in the event the at least one server has not been reserved by the one of the administrators.

8. The computer arrangement according to claim 7, wherein the deployment server is operable to transmit a response message an administrator requesting a reservation, the response message indicating whether the reservation is granted or denied.

9. The computer arrangement according to claim 8, wherein the reservation request relates to reservation of a plurality of the servers, and the response message identifies which of the servers are reserved.

10. The computer arrangement according to claim 8, wherein requests to and response messages from the deployment server are in the form of mark-up language based transactions.

11. The computer arrangement according to claim 10, wherein the requests to and the response message from the deployment server are in the form of XML-based (eXtensible Markup Language) transactions.

12. The computer arrangement according to claim 7, wherein the deployment server is configured to receive reservation requests from a user.
